(19) United States
(12) Patent Application Publication
(10) Pub. No.: US 2023/0267839 A1
(43) Pub. Date: Aug. 24, 2023

(54) A METHOD OF OPTIMISING AIRSPACE BLOCKS WITHIN AN AIRSPACE

(71) Applicant: AIRSPACE UNLIMITED SCOTLAND LTD, Stonebyres Lanark (GB)

(72) Inventors: Martin John HAWLEY, Richmond Surrey (GB); Denis KOLEV, Lancaster Lancashire (GB); Douglas Stephen MEYER-HOFF, Stonebyres, Lanark (GB); Mikhail SUVOROV, Moscow (RU)

(73) Assignee: AIR SPACE UNLIMITED SCOTLAND LTD, Stonebyres Lanark (GB)

(21) Appl. No.: 18/041,331

(22) PCT Filed: Aug. 12, 2021
(86) PCT No.: PCT/GB2021/052098

§ 371 Date: Feb. 10, 2023

(30) Foreign Application Priority Data
Aug. 12, 2020 (GB) 2012578.7

(51) Int. Cl. G08G 5/00

(52) U.S. Cl. CPC G08G 5/0017; G08G 5/0039; B64U 10/00

(57) ABSTRACT

A computer-implemented method of optimising one or more airspace blocks within an airspace. The method comprises receiving the initial spatial coordinates and the initial temporal coordinates of one or more initial airspace blocks within the airspace; receiving one or more pairs of waypoints within the airspace; and receiving or calculating an initial flight path between each pair of waypoints. The method further comprises iteratively optimising the spatial coordinates and the temporal coordinates of the one or more airspace blocks by iteratively modifying the spatial coordinates and the temporal coordinates of the one or more airspace blocks, calculating corresponding modified flight paths between each of the pairs of waypoints where the modified flight paths are in compliance with the availability of the modified airspace blocks, and for each iteration calculating the modified total objective variable.

### TECHNICAL FIELD

The present disclosure relates to a computer-implemented method of optimising one or more airspace blocks within an airspace, and particularly, but not exclusively, to a computer-implemented method of optimising one or more airspace blocks within an airspace in which initial airspace blocks are iteratively optimised.

### BACKGROUND

Flight path planning is critical to the aviation industry as optimised flight paths allow for a reduction of flight time, fuel burn and greenhouse gas emissions.

One major limitation to the planning of flight paths is unavailable airspace blocks through which a flight path cannot be routed. If such unavailable airspace blocks are present in the airspace, the flight path must be routed to bypass any such unavailable airspace blocks which typically results in a sub-optimum flight path.

Unavailable airspace blocks may be present for a variety of reasons, such as a military airspace restriction or a civil route closure.

Current flight planning concepts account for any unavailable airspace blocks by optimising the flight paths taking such unavailable airspace blocks into account.

However, there is a need for an improved method for allowing the planning of flight paths in a given airspace which includes unavailable airspace blocks.

### SUMMARY

Accordingly, it is an object of the present disclosure to provide an improved method for allowing the planning of flight paths in a given airspace which includes unavailable airspace blocks.

These objectives and related objectives are achieved with the method of claim 1, the method of claim 10 and the non-transitory computer-readable medium of claim 12.

Preferred implementations/embodiments are recited in the dependent claims.

There is provided a computer-implemented method of optimising one or more airspace blocks within an airspace, the method comprising: receiving the initial spatial coordinates and the initial temporal coordinates of one or more initial airspace blocks within the airspace; receiving one or more pairs of waypoints within the airspace, where each pair of waypoints define the start and end of a flight path through the airspace; receiving or calculating an initial flight path between each pair of waypoints, where each initial flight path is in compliance with the availability of the one or more initial airspace blocks, where each initial flight path has an objective variable associated therewith, and where the sum of the objective variables of the initial flight paths defines a total objective variable; and iteratively optimising the spatial coordinates and the temporal coordinates of the one or more airspace blocks by: iteratively modifying the spatial coordinates and the temporal coordinates of the one or more airspace blocks, calculating corresponding modified flight paths between each of the pairs of waypoints where the modified flight paths are in compliance with the availability of the modified airspace blocks, and for each iteration calculating the modified total objective variable, wherein the optimisation reduces the modified total objective variable relative to the initial total objective variable and outputs the corresponding optimised spatial coordinates and the temporal coordinates of the one or more optimised airspace blocks.

With such implementations, the airspace blocks are not treated as fixed in space and/or time. Instead, the airspace blocks are instead changed in space and/or time so as to optimise the spatial and/or temporal coordinates of the airspace blocks whilst taking into account the specific pairs of waypoints required in the airspace.

With such steps, the method allows for more optimised planning of flight paths in a given airspace which includes unavailable airspace blocks.

Airspace blocks may be unavailable or available. For example, unavailable airspace blocks may be caused due to a military airspace restriction, civil route closure, a permanently closed airspace, or a region of significant meteorological event or condition, SIGMET.

As would be understood by the skilled person in the art, airspace blocks may be volumes of airspace defined by 3D coordinates and may include a temporal coordinate.

As would be understood by the skilled person in the art, waypoints are defined by a geographical point in space and time and may define a point along the flight path (for example, the start point or the end point of the flight path).

As would be understood by the skilled person in the art, the use of the term ‘optimised’ herein does not necessarily require the absolute ‘best’ solution, instead, the term merely requires that the step seeks to improve the solution to some extent.

In certain implementations, the one or more airspace blocks comprise at least one unavailable airspace block.

In certain implementations, the calculation of the modified flight paths between each pair of waypoints comprises optimising each flight path between the pairs of waypoints ensuring compliance with the availability of the one or more modified airspace blocks.

With such implementations, each flight path is optimised based on the specific modified one or more airspace blocks allowing for a calculation of the optimised total objective variable for the specific modified one or more airspace blocks.

In certain implementations, the optimisation of each flight path comprises reducing the objective variable of the flight path.

In certain implementations, the optimisation is solved by a graph path optimizer such as the Dijkstra's algorithm or the Bellman-Ford algorithm.

In certain implementations, the method further comprises receiving weather data for the airspace, and wherein the step of optimising each flight path comprises receiving the weather data as an input variable for the optimisation.

With such implementations, the optimisation of the flight paths in view of the modified one or more airspace blocks takes into account weather data for the airspace. Accordingly, the airspace blocks are further optimally placed and/or timed taking advantage of any potential weather data. Therefore, such implementations further optimised planning of flight paths in a given airspace which includes unavailable airspace blocks.

In certain implementations, the method further comprises receiving an aircraft performance model, and wherein the step of optimising each flight path comprises receiving the aircraft performance model as an input variable for the optimisation.

With such implementations, the optimisation of the flight paths in view of the modified one or more airspace blocks takes into account weather data for the airspace together with the specific aircraft performance model for the flight path. Accordingly, the airspace blocks are further optimally placed and/or timed taking advantage of any potential weather data and the specific aircraft performance model. Therefore, such implementations further optimised planning of flight paths in a given airspace which includes unavailable airspace blocks.

In certain implementations, the weather data is wind data and/or wherein the weather data is forecast weather data.

In certain implementations, the objective variable is: the flight time; the flight emissions, such as CO₂, CH₄, N₂O, O₃ or other greenhouse gas; or the flight cost, where the flight cost is a sum of the route cost and the ANS charges for the flight path.

As would be understood by the skilled person, the route cost is the combination of fixed and variable costs for the specific flight path.

In certain implementations, at least one or all of the at least one airspace blocks is a military airspace restriction, civil route closure, a permanently closed airspace, or a region of significant meteorological event or condition, SIGMET.

In certain implementations, the step of iteratively optimising the spatial coordinates and the temporal coordinates of the one or more airspace blocks comprises optimising the spatial coordinates and the temporal coordinates of each of the one or more airspace blocks individually each by: iteratively modifying the spatial coordinates and the temporal coordinates of the individual airspace blocks, calculating corresponding modified flight paths between each of the pairs of waypoints where the modified flight paths are in compliance with the modified individual airspace block, and for each iteration calculating the modified total objective variable, wherein the optimisation reduces the modified total objective variable relative to the initial total objective variable and outputs the corresponding optimised spatial coordinates and the temporal coordinates of the individual airspace block.

In certain implementations, the step of iteratively optimising the spatial coordinates and the temporal coordinates of the one or more airspace blocks comprises optimising the spatial coordinates and the temporal coordinates of each of the one or more airspace blocks individually and in turn, each by: iteratively modifying the spatial coordinates and the temporal coordinates of the individual airspace blocks, calculating corresponding modified flight paths between each of the pairs of waypoints where the modified flight paths are in compliance with the modified individual airspace block, and for each iteration calculating the modified total objective variable, wherein the optimisation reduces the modified total objective variable relative to the initial total objective variable and outputs the corresponding optimised spatial coordinates and the temporal coordinates of the individual airspace block.

In certain implementations, the method further includes the step of calculating a flight path between a pair of waypoints, where the calculated flight path is in compliance with the availability of the optimised one or more airspace blocks.

There is further provided a method of flying an aircraft through an airspace, the method comprising: optimising one or more airspace blocks within an airspace in accordance with the method of optimising one or more airspace blocks within an airspace disclosed anywhere herein; calculating a flight path between a pair of waypoints, where the calculated flight path is in compliance with the availability of the optimised one or more airspace blocks; and flying an aircraft through the airspace along the calculated flight path.

With such implementations, the flight of the aircraft is optimised such that there is a potential reduction in fuel burn (or general energy consumption), potentially greenhouse gas emissions and flight time.

In certain implementations, the aircraft is an unmanned aerial vehicle such as an autonomous UAV or remotely piloted drone, and wherein the autonomous aircraft or drone autonomously flies along the calculated flight path.

There is further provided a non-transitory computer-readable medium having computer-executable instructions adapted to carry out the method of optimising one or more airspace blocks within an airspace disclosed anywhere herein.

With such implementations, the method stored on the non-transitory computer-readable medium allows for more optimised planning of flight paths in a given airspace which includes unavailable airspace blocks.

### BRIEF DESCRIPTION OF DRAWINGS

Embodiments of the present disclosure will now be described by way of example only, with reference to the following diagrams, in which:—

FIG. 1 shows a flow chart for a method of optimising one or more airspace blocks within an airspace;

FIG. 2 shows part of a flow chart for an optional part of the flow chart shown in FIG. 1;

FIG. 3 shows an exemplary representation of initial airspace blocks in an airspace; and

FIG. 4 shows an exemplary representation of an optimisation of the initial airspace blocks shown in FIG. 3.

### DETAILED DESCRIPTION

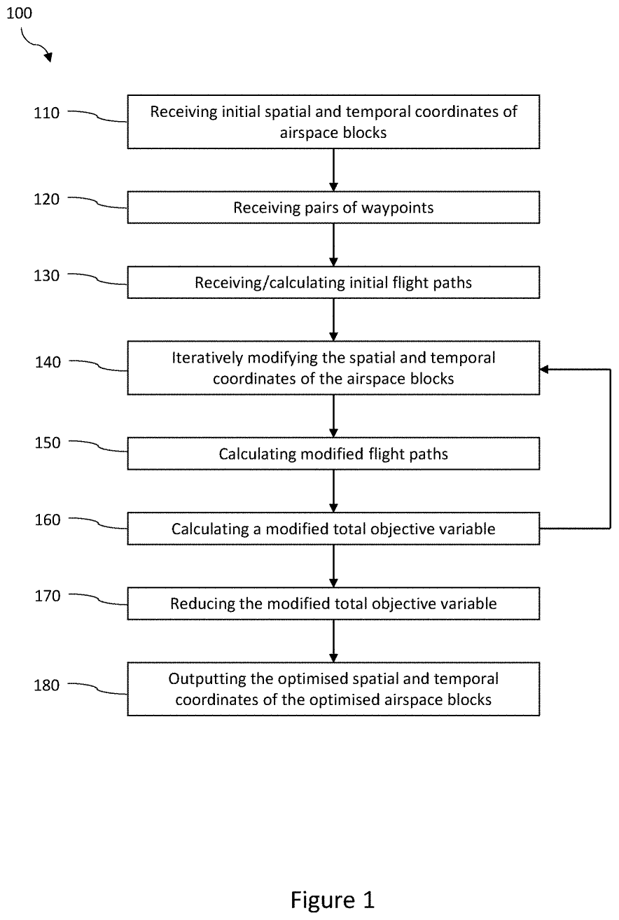

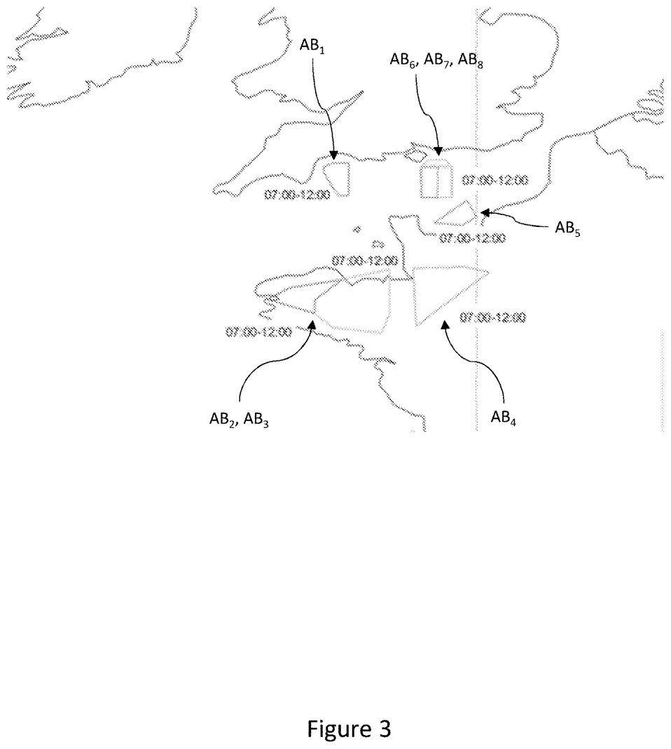

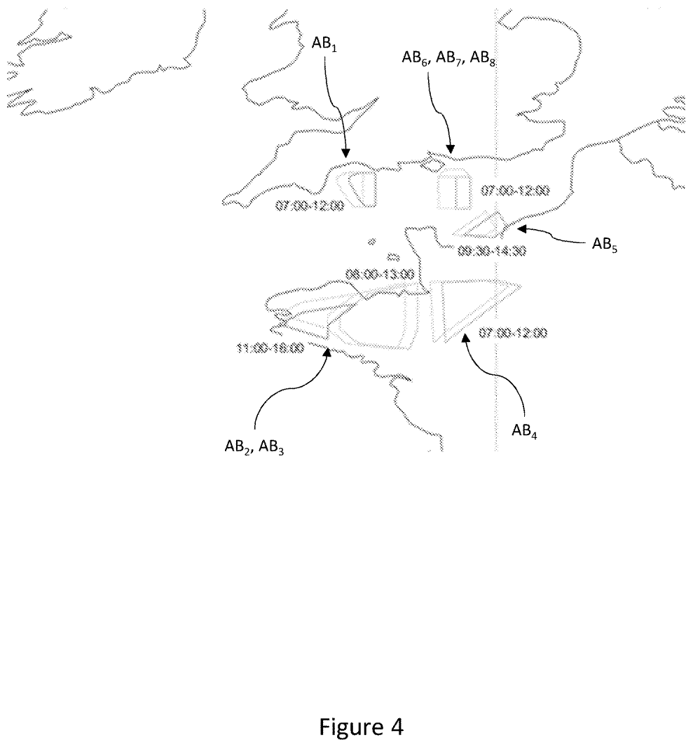

FIG. 1 shows a flow chart for a method 100 of optimising (in space and/or time) one or more airspace blocks AB₁ to AB₈ (shown in FIGS. 3 and 4) within an airspace. The method 100 may be computer-implemented in any manner known to the person skilled in the art. For example, the method 100 may be implemented on a computer sever or a personal computer with input and output means typically known in the art.

The method 100 includes the step 110 of receiving initial spatial coordinates and initial temporal coordinates of one or more initial airspace blocks AB₁ to AB₈ within the airspace. The initial spatial and temporal coordinates of the one or more initial airspace blocks AB₁ to AB₈ may be received in any manner, for example, by a user manually entering the information using an input means of the computer system in which the method 100 is implemented on, or by the computer system receiving the information from a network connection (such as a LAN/internet network connection).

The method 100 further includes the step 120 of receiving one or more pairs of waypoints within the airspace, where each pair of waypoints define the start and end of a flight path through the airspace. The one or more pairs of waypoints may be received in any manner, for example, by a user manually entering the information using an input means of the computer system in which the method 100 is implemented on, or by the computer system receiving the information from a network connection (such as a LAN/internet network connection).

The method 100 further includes the step 130 of receiving or calculating an initial flight path between each pair of waypoints, where each initial flight path is in compliance with the availability of the one or more initial airspace blocks. Each initial flight path has an objective variable associated therewith, and the sum of the objective variables of the initial flight paths defines a total objective variable. If the step 130 includes receiving the initial flight paths (instead of calculating them), said information may be received in any manner, for example, by a user manually entering the information using an input means of the computer system in which the method 100 is implemented on, or by the computer system receiving the information from a network connection (such as a LAN/internet network connection).

If the step 130 includes calculating the initial flight paths (instead of receiving them), the method 100 may carry out such a calculation in any manner. For example, the initial flight paths may be calculated by optimisation (in view of the airspace blocks AB₁ to AB₈) using a graph path optimizer such as the Dijkstra's algorithm or the Bellman-Ford algorithm. The inputs to any such optimisation would include the specific flight path waypoints.

The method further includes iteratively optimising the spatial coordinates and the temporal coordinates of the one or more airspace blocks AB₁ to AB₈ by: the step 140 of iteratively modifying the spatial coordinates and the temporal coordinates of the one or more airspace blocks AB₁ to AB₈, the step 150 of calculating corresponding modified flight paths between each of the pairs of waypoints where the modified flight paths are in compliance with the availability of the modified airspace blocks AB₁ to AB₈, and the step of calculating the modified total objective variable.

Optionally, the step 150 of calculating corresponding modified flight paths between pairs of waypoints comprises optimising each flight path between the pairs of waypoints ensuring compliance with the availability of the one or more modified airspace blocks AB₁ to AB₈.

Optionally, the step 150 of calculating corresponding modified flight paths between pairs of waypoints comprises optimising each flight path between the pairs of waypoints ensuring compliance with the availability of the one or more modified airspace blocks AB₁ to AB₈ whilst reducing the objective variable of the flight path.

Optionally, the step 150 of calculating corresponding modified flight paths includes optimising the flight path using a graph path optimizer such as the Dijkstra's algorithm or the Bellman-Ford algorithm.

Optionally, the step 150 of calculating corresponding modified flight paths between pairs of waypoints comprises receiving weather data for the airspace, and optimising each flight path by receiving the weather data as an input variable for the optimisation. Optionally, the step 150 further comprises receiving an aircraft performance model, and wherein the step of optimising each flight path comprises receiving the aircraft performance model as an input variable for the optimisation.

Optionally, the weather data is wind data and/or wherein the weather data is forecast weather data.

The optimisation of the spatial coordinates and the temporal coordinates of the one or more airspace blocks AB₁ to AB₈ includes the step 170 of reducing the modified total objective variable relative to the initial total objective variable.

The method further includes the step 180 of outputting the corresponding optimised spatial coordinates and the temporal coordinates of the one or more optimised airspace blocks AB₁ to AB₈.

As used herein, the objective variable may be: the flight time; the flight emissions, such as CO2, CH4, N2O, O3 or other greenhouse gas; or the flight cost, where the flight cost is a sum of the route cost and the ANS charges for the flight path.

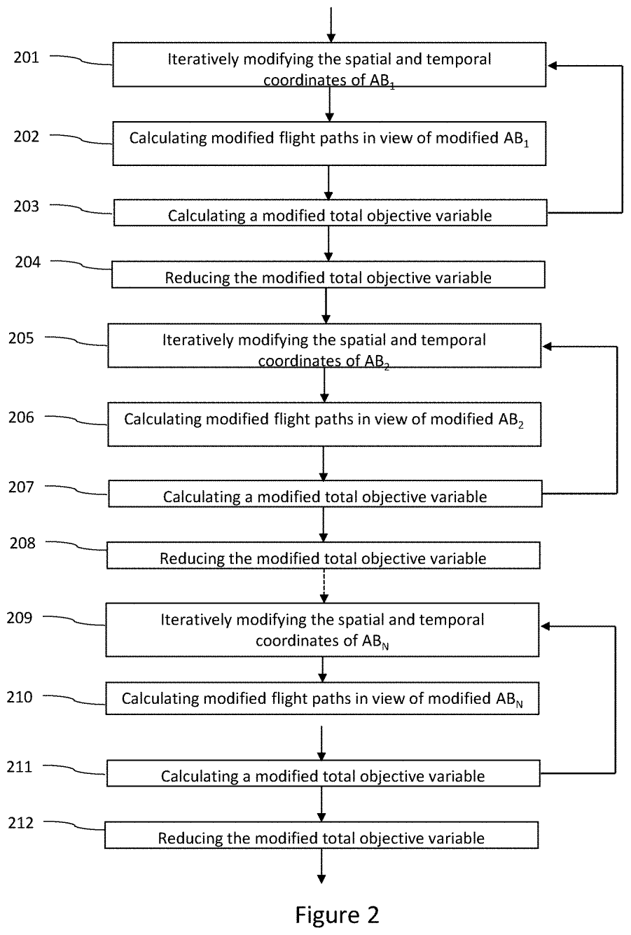

FIG. 2 shows part of a flow chart for an optional part of the method of FIG. 1. In particular, the steps shown in FIG. 2 are a particular way to carry out steps 140, 150 and of the method of FIG. 1.

In general, FIG. 2 shows that in steps 140, 150 and 160, each airspace block AB₁ to AB₈ is optimised individually and in turn, for example, by starting with the first airspace block AB₁.

Specifically, the method includes the step of iteratively optimising the spatial coordinates and the temporal coordinates of the first airspace block AB₁ by: the step 201 of iteratively modifying the spatial coordinates and the temporal coordinates of the first airspace block AB₁, the step 202 of calculating corresponding modified flight paths between each of the pairs of waypoints where the modified flight paths are in compliance with the availability of the airspace blocks AB₁ to AB₈, and the step 203 of calculating the modified total objective variable.

The optimisation of the spatial coordinates and the temporal coordinates of the first airspace block AB₁ includes the step 204 of reducing the modified total objective variable relative to the initial total objective variable.

Thereafter, the method includes the step of iteratively optimising the spatial coordinates and the temporal coordinates of the second airspace block AB₂ by: the step 205 of iteratively modifying the spatial coordinates and the temporal coordinates of the second airspace block AB₂, the step 206 of calculating corresponding modified flight paths between each of the pairs of waypoints where the modified flight paths are in compliance with the availability of the airspace blocks AB₁ to AB₈, and the step 207 of calculating the modified total objective variable.

The optimisation of the spatial coordinates and the temporal coordinates of the second airspace block AB₂ includes the step 208 of reducing the modified total objective variable relative to the initial total objective variable.

These steps are repeated for all airspace blocks AB₁ to AB₈ until all airspace blocks AB₁ to AB₈ have been optimised. Thereafter, the method 100 proceeds as shown in FIG. 1.

FIG. 3 shows an exemplary representation of initial airspace blocks AB₁ to AB₈ in an airspace. As can be seen in FIG. 3, each airspace blocks AB₁ to AB₈ is defined by a volume in 3D coordinates and a time in temporal coordinates. The initial airspace blocks AB₁ to AB₈ may be received in step 110 of method 100.

FIG. 4 shows an exemplary representation of optimised airspace blocks AB₁ to AB₈ outputted by the method 100 shown in FIG. 1. Specifically, the various airspace blocks AB₁ to AB₈ have been modified in space and/or time.

In particular, the first airspace block AB₁ has been translated to the right but maintained at the same time.

The second airspace block AB₂ has been translated downwardly and delayed by four hours.

The third airspace block AB₃ has been translated to the right and delayed by one hour.

The fourth airspace block AB₄ has been translated to the right but maintained at the same time.

The fifth airspace block AB₅ has been translated to the right and delayed by two and a half hours.

The sixth and seventh airspace blocks AB₆, AB₇ have been removed.

The eighth airspace block AB₈ has been translated to the right but maintained at the same time.

The optimised airspace blocks AB₁ to AB₈ shown in FIG. 4 may be outputted by the method 100 in step 180 in any manner. For example, by the computer system outputting the information on output means of the computer system (such as a graphical interface or printer), or by the computer system sending the information via a network connection (such as a LAN/internet network connection) to another computer system.

Although particular embodiments of the disclosure have been disclosed herein in detail, this has been done by way of example and for the purposes of illustration only. The aforementioned embodiments are not intended to be limiting with respect to the scope of the appended claims.

It is contemplated by the inventors that various substitutions, alterations, and modifications may be made to the invention without departing from the scope of the invention as defined by the claims. Examples of these include the following:—

The order of the steps disclosed herein may be changed as would be understood by the person skilled in the art. For example, the order of steps 110 and 120 may be switched freely.

Furthermore, the above example uses eight airspace blocks, however, as would be understood by the skilled person, the number of airspace blocks used in the method may be changed freely.

1. A computer-implemented method of optimising one or more airspace blocks within an airspace, the method comprising:
receiving the initial spatial coordinates and the initial temporal coordinates of one or more initial airspace blocks within the airspace;
receiving one or more pairs of waypoints within the airspace, where each pair of waypoints define the start and end of a flight path through the airspace;
receiving or calculating an initial flight path between each pair of waypoints, where each initial flight path is in compliance with the availability of the one or more initial airspace blocks, where each initial flight path has an objective variable associated therewith, and where the sum of the objective variables of the initial flight paths defines a total objective variable; and
iteratively optimising the spatial coordinates and the temporal coordinates of the one or more airspace blocks by: iteratively modifying the spatial coordinates and the temporal coordinates of the one or more airspace blocks, calculating corresponding modified flight paths between each of the pairs of waypoints where the modified flight paths are in compliance with the availability of the modified airspace blocks, and for each iteration calculating the modified total objective variable, wherein the optimisation reduces the modified total objective variable relative to the initial total objective variable and outputs the corresponding optimised spatial coordinates and the temporal coordinates of the one or more optimised airspace blocks.

2. The method of claim 1, wherein the calculation of the modified flight paths between each pair of waypoints comprises optimising each flight path between the pairs of waypoints ensuring compliance with the availability of the one or more modified airspace blocks.

3. The method of claim 2, wherein the optimisation of each flight path comprises reducing the objective variable of the flight path.

4. The method of claim 2, wherein the optimisation of each flight path is solved by a graph path optimizer such as the Dijkstra's algorithm or the Bellman-Ford algorithm.

5. The method of claim 2, wherein the method further comprises receiving weather data for the airspace, and wherein the step of optimising each flight path comprises receiving the weather data as an input variable for the optimisation, and wherein the method further comprises receiving an aircraft performance model, and wherein the step of optimising each flight path comprises receiving the aircraft performance model as an input variable for the optimisation.

6. The method of claim 5, wherein the weather data is at least one of wind data and forecast weather data.

7. The method of claim 1, wherein the objective variable is: the flight time; the flight emissions, such as CO₂, CH₄, N₂O, O₃ or other greenhouse gas; or the flight cost, where the flight cost is a sum of the route cost and the ANS charges for the flight path.

8. The method of claim 1, wherein at least one of the at least one airspace blocks is a military airspace restriction, a civil route closure, a permanently closed airspace, or a region of significant meteorological event or condition, SIGMET.

9. The method of claim 1, wherein the step of iteratively optimising the spatial coordinates and the temporal coordinates of the one or more airspace blocks comprises optimising the spatial coordinates and the temporal coordinates of each of the one or more airspace blocks individually each by: iteratively modifying the spatial coordinates and the temporal coordinates of the individual airspace blocks, calculating corresponding modified flight paths between each of the pairs of waypoints where the modified flight paths are in compliance with the modified individual airspace block, and for each iteration calculating the modified total objective variable, wherein the optimisation reduces the modified total objective variable relative to the initial total objective variable and outputs the corresponding optimised spatial coordinates and the temporal coordinates of the individual airspace block.

10. A method of flying an aircraft through an airspace, the method comprising:
optimising one or more airspace blocks within an airspace in accordance with the method of claim 1;
calculating a flight path between a pair of waypoints, where the calculated flight path is in compliance with the availability of the optimised one or more airspace blocks; and
flying an aircraft through the airspace along calculated flight path.

11. The method of claim 10, wherein the aircraft is an unmanned aerial vehicle such as an autonomous UAV or remotely piloted drone, and wherein the autonomous aircraft or drone autonomously flies along the calculated flight path.

12. A non-transitory computer-readable medium having computer-executable instructions adapted to carry out the method of claim 1.

13. A non-transitory computer-readable medium having computer-executable instructions adapted to carry out the method of claim 10.
